(19) United States
(12) Patent Application Publication
(10) Pub. No.: US 2024/0103657 A1
(43) Pub. Date: Mar. 28, 2024

(54) TOUCH CONTROL METHOD FOR CIRCULAR SCREEN, TERMINAL DEVICE AND STORAGE MEDIUM

(71) Applicant: GOERTEK INC., Weifang, Shandong (CN)

(72) Inventor: Long WANG, Weifang, Shandong (CN)

(21) Appl. No.: 18/266,290

(22) PCT Filed: Nov. 17, 2021
(86) PCT No.: PCT/CN2021/131084

§ 371 Date: Jun. 9, 2023

(30) Foreign Application Priority Data
Dec. 9, 2020 (CN) 202011431583.5

(51) Int. Cl. G06F 3/041

(52) U.S. Cl. CPC G06F 3/0416

(57) ABSTRACT

Some embodiments of the disclosure disclose a touch control method for a circular screen, a terminal device and a storage medium. The steps of the method include: determining a start touch point and an end touch point corresponding to a touch operation, and determining a function to be adjusted according to position areas of the start touch point and the end touch point on the circular screen; determining a corresponding adjustment type according to relative position relationship between the start touch point and the end touch point; determining a corresponding adjustment value according to an angle formed by a line connecting the start touch point and a center of the circle screen and an angle formed by a line connecting the end touch point and the center of the circle screen; and adjusting the function to be adjusted according to the adjustment value and the adjustment type.

The disclosure claims the priority of the Chinese Patent Application No. 202011431583.5, titled “touch control method for circular screen, terminal device and storage medium” filed in China Patent Office on Dec. 9, 2020, the entire contents of which are combined into the disclosure by reference.

### TECHNICAL FIELD

The disclosure relates to technical fields of touch control and a circular screen terminal device, and more particularly, to a touch control method for a circular screen, a terminal device and a storage medium.

### DESCRIPTION OF RELATED ART

With the development of intelligent devices and the emergence of a shortcut operation mode, the function adjustment for the intelligent devices becomes more and more convenient. For example, voice and brightness of a smart phone may be adjusted by sliding an edge area of a screen of the smart phone. However, presently, the shortcut operation mode is mainly applied in intelligent devices with square shapes, but not in intelligent devices with circular screens, such as smart watches.

The above content is only used to help understanding technical solutions of the disclosure, but does not mean that the above content is recognized as a prior art.

### SUMMARY

A main purpose of the disclosure is to provide a touch control method for a circular screen, a terminal device and a storage medium, to realize a shortcut operation for the terminal device with the circular screen.

In order to achieve the above purpose, an embodiment of the disclosure provides a touch control method for a circular screen, wherein the touch control method for the circular screen is applied to a terminal device with the circular screen, the touch control method for the circular screen includes:
determining a start touch point and an end touch point corresponding to a touch operation, and determining a function to be adjusted according to position areas of the start touch point and the end touch point on the circular screen; determining a corresponding adjustment type according to relative position relationship between the start touch point and the end touch point; determining a corresponding adjustment value according to an angle formed by a line connecting the start touch point and a center of the circle screen and an angle formed by a line connecting the end touch point and the center of the circle screen; and adjusting the function to be adjusted according to the adjustment value and the adjustment type.

Optionally, adjusting the function to be adjusted according to the adjustment value and the adjustment type includes:
determining a current function value of the function to be adjusted; determining a corresponding target adjustment value according to the current function value, the adjustment value and the adjustment type; and adjusting the current function value of the function to be adjusted to the target adjustment value.

Optionally, the adjustment type includes an increasing adjustment type and a decreasing adjustment type, and determining the corresponding target adjustment value according to the current function value, the adjustment value and the adjustment type includes:
determining a sum of the current function value and the adjustment value as the target adjustment value if the adjustment type is the increasing adjustment type; and determining a difference between the current function value and the adjustment value as the target adjustment value if the adjustment type is the decreasing adjustment type.

Optionally, determining the corresponding adjustment type according to the relative position relationship between the start touch point and the end touch point includes:
determining a first vertical coordinate corresponding to the start touch point, and determining a second vertical coordinate corresponding to the end touch point; determining the relative position relationship between the start touch point and the end touch point according to the relative difference between the first vertical coordinate and the second vertical coordinate; and determining the corresponding adjustment type according to the relative position relationship between the start touch point and the end touch point.

Optionally, determining the corresponding adjustment value according to the angle formed by the line connecting the start touch point and the center of the circle screen and the angle formed by the line connecting the end touch point and the center of the circular screen includes:
determining the angle formed by the line connecting the start touch point and the center of the circle screen as a first angle, and determining the angle formed by the line connecting the end touch point and the center of the circular screen as a second angle; determining a corresponding target adjustment angle according to the first vertical coordinate, the second vertical coordinate, the first angle and the second angle; and determining the adjustment value according to the target adjustment angle and a current function value of the function to be adjusted.

Optionally, determining the function to be adjusted according to the position areas of the start touch point and the end touch point on the circular screen includes:
determining a first horizontal coordinate corresponding to the start touch point, and determining a second horizontal coordinate corresponding to the end touch point; determining a first position area of the start touch point on the circular screen according to the ratio of the first horizontal coordinate to a screen radius of the circular screen; determining a second position area of the end touch point on the circular screen according to the ratio of the second horizontal coordinate to the screen radius of the circular screen; and determining a corresponding function to be adjusted according to the first position area and the second position area.

Optionally, before determining the start touch point and the end touch point corresponding to the touch operation, the method also includes:
determining a preset circle radius, and determining an edge area corresponding to the circular screen according to a screen radius of the circular screen and the preset circle radius.

Optionally, determining the start touch point and the end touch point corresponding to the touch operation includes:
determining that a touch point is the start touch point of a user's finger when it is detected that the user's finger touches the circular screen and it is determined that the touch point is in the edge area corresponding to the circular screen; and determining that an end point of a sliding track is the end touch point of the user's finger when it is detected that the sliding track of the user's finger starting from the start touch point is in the edge area.

The embodiment of the disclosure also provides a terminal device including a memory, a processor and a touch control program for a circular screen stored in the memory and running on the processor, wherein when the touch control program for the circular screen is executed by the processor, steps of the touch control method for the circular screen as described above are performed.

The embodiment of the disclosure also provides a storage medium on which a touch control program for a circular screen is stored, wherein when the touch control program for the circular screen is executed by the processor, steps of the touch control method for the circular screen as described above are performed.

The touch control method for the circular screen, the terminal device and the storage medium provided by the embodiment of the disclosure includes: determining a start touch point and an end touch point corresponding to a touch operation, and determining a function to be adjusted according to position areas of the start touch point and the end touch point on the circular screen; determining a corresponding adjustment type according to relative position relationship between the start touch point and the end touch point; determining a corresponding adjustment value according to an angle formed by a line connecting the start touch point and a center of the circle screen and an angle formed by a line connecting the end touch point and the center of the circle screen; and adjusting the function to be adjusted according to the adjustment value and the adjustment type. Thus, it can be known that, in the disclosure, during the process of adjusting the function to be adjusted, the corresponding function to be adjusted, the adjustment type and the adjustment value are determined by the start touch point and the end touch point, and the function to be adjusted is determined by the adjustment value and the adjustment type, so as to realize the shortcut operation of the function to be adjusted in the terminal device with the circular screen.

### BRIEF DESCRIPTION OF DRAWINGS

In order to illustrate the embodiments of the disclosure or the technical solutions in the prior art more clearly, the drawings required to be used in the content of the embodiments or the prior art will be introduced briefly as following. Obviously, the drawings in the following description are merely a part of the drawings of the disclosure and for those of ordinary skill in the art, other drawings can also be obtained from the provided drawings without any creative effort.

FIG. 1 is a schematic diagram of a structure of the terminal device of a hardware operation environment related to the embodiment of the disclosure;

FIG. 2 is a flowchart of a first embodiment of the touch control method of the disclosure;

FIG. 3 is an application scene graph of an embodiment of the touch control method of the disclosure;

FIG. 4 is a schematic diagram of types of edge touch screen events of an embodiment of the touch control method of the disclosure;

FIG. 5 is a detailed flowchart of a step S20 in the first embodiment of the touch control method of the disclosure;

FIG. 6 is a detailed flowchart of a step S40 in the first embodiment of the touch control method of the disclosure; and

FIG. 7 is a detailed flowchart of a step S50 in the first embodiment of the touch control method of the disclosure.

### DETAILED DESCRIPTIONS

It should be understood that the specific embodiments described herein are only used to explain the disclosure and not to limit the disclosure.

A main solution of the embodiment of the disclosure is: determining a start touch point and an end touch point corresponding to a touch operation, and determining a function to be adjusted according to position areas of the start touch point and the end touch point on the circular screen; determining a corresponding adjustment type according to relative position relationship between the start touch point and the end touch point; determining a corresponding adjustment value according to an angle formed by a line connecting the start touch point and a center of the circle screen and an angle formed by a line connecting the end touch point and the center of the circle screen; and adjusting the function to be adjusted according to the adjustment value and the adjustment type. Thus, it can be known that, in the disclosure, during the process of adjusting the function to be adjusted, the corresponding function to be adjusted, the adjustment type and the adjustment value are determined by the start touch point and the end touch point, and the function to be adjusted is determined by the adjustment value and the adjustment type, so as to realize the shortcut operation of the function to be adjusted in the terminal device with the circular screen.

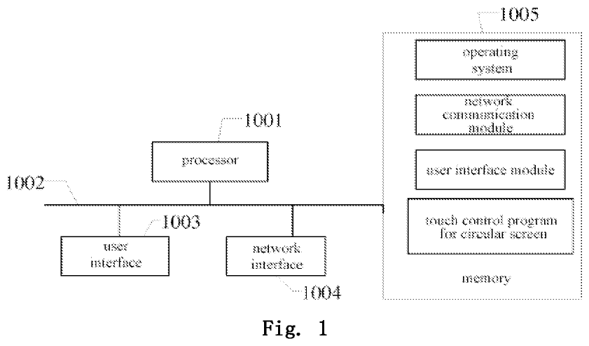

Specifically, please refer to FIG. 1, which is a schematic diagram of a structure of the terminal device of a hardware operation environment related to the embodiment of the disclosure. The terminal device may include: a processor 1001, such as CPU (Central Processing Unit); a memory 1005; a user interface 1003; a network interface 1004 and a communication bus 1002. The communication bus 1002 is used to perform connection and communication between these components. The user interface 1003 may include a display and an input unit such as a keyboard. Optionally, the user interface 1003 may also include a standard wired interface (such as a USB (Universal Serial Bus) interface) and a wireless interface (such as a Bluetooth interface). The network interface 1004 may include a standard wired interface and a wireless interface (such as a WI-FI (Wireless Identity) interface). The memory 1005 may be a high-speed RAM memory or a non-volatile memory such as a disk memory. Optionally, the memory 1005 may be a storage device independent of the above processor 1001. Optionally, the terminal device may also include a RF (Radio Frequency) circuit, a sensor, a WiFi module, etc.

It is understood by those skilled in the art that the structure of the terminal device as shown in FIG. 1 does not constitute a limitation to the terminal device, more or fewer components than that shown in the drawing may be included, some components may be combined, or it might be provided with different components.

As shown in FIG. 1, the memory 1005, as a computer storage medium (it should be noted that the computer storage medium in the disclosure is a computer-readable storage medium), may include an operating system, a network communication module, a user interface module and a touch control program for a circular screen. Wherein, the operating system is a program for managing and controlling e hardware and software resources of the terminal device, which supports the operation of the touch control program for the circular screen and other software or programs.

In the terminal device as shown in FIG. 1, the network interface 1004 is mainly used to connect to a background server and to communicate data with the background server; and the user interface 1003 is mainly used to connect to a client and to communicate data with the client. Wherein, the processor 1001 may be used to call the touch control program for the circular screen stored in the memory 1005 and to perform the following operations:

determining a start touch point and an end touch point corresponding to a touch operation, and determining a function to be adjusted according to position areas of the start touch point and the end touch point on the circular screen;

determining a corresponding adjustment type according to relative position relationship between the start touch point and the end touch point;

determining a corresponding adjustment value according to an angle formed by a line connecting the start touch point and a center of the circle screen and an angle formed by a line connecting the end touch point and the center of the circle screen; and

adjusting the function to be adjusted according to the adjustment value and the adjustment type.

Further, the processor 1001 may call the touch control program for the circular screen stored in the memory 1005, and also perform the following operations:
determining a current function value of the function to be adjusted;
determining a corresponding target adjustment value according to the current function value, the adjustment value and the adjustment type; and
adjusting the current function value of the function to be adjusted to the target adjustment value.

Further, the processor 1001 may call the touch control program for the circular screen stored in the memory 1005, and also perform the following operations:
determining a sum of the current function value and the adjustment value as the target adjustment value if the adjustment type is the increasing adjustment type; and
determining a difference between the current function value and the adjustment value as the target adjustment value if the adjustment type is the decreasing adjustment type.

Further, the processor 1001 may call the touch control program for the circular screen stored in the memory 1005, and also perform the following operations:
determining a first vertical coordinate corresponding to the start touch point, and determining a second vertical coordinate corresponding to the end touch point;
determining the relative position relationship between the start touch point and the end touch point according to the relative difference between the first vertical coordinate and the second vertical coordinate; and
determining the corresponding adjustment type according to the relative position relationship between the start touch point and the end touch point.

Further, the processor 1001 may call the touch control program for the circular screen stored in the memory 1005, and also perform the following operations:
determining the angle formed by the line connecting the start touch point and the center of the circle screen as a first angle, and determining the angle formed by the line connecting the end touch point and the center of the circular screen as a second angle;
determining a corresponding target adjustment angle according to the first vertical coordinate, the second vertical coordinate, the first angle and the second angle; and
determining the adjustment value according to the target adjustment angle and a current function value of the function to be adjusted.

Further, the processor 1001 may call the touch control program for the circular screen stored in the memory 1005, and also perform the following operations:
determining a first horizontal coordinate corresponding to the start touch point, and determining a second horizontal coordinate corresponding to the end touch point;
determining a first position area of the start touch point on the circular screen according to the ratio of the first horizontal coordinate to a screen radius of the circular screen;
determining a second position area of the end touch point on the circular screen according to the ratio of the second horizontal coordinate to the screen radius of the circular screen; and
determining a corresponding function to be adjusted according to the first position area and the second position area.

Further, the processor 1001 may call the touch control program for the circular screen stored in the memory 1005, and also perform the following operations:
determining a preset circle radius, and determining an edge area corresponding to the circular screen according to a screen radius of the circular screen and the preset circle radius.

Further, the processor 1001 may call the touch control program for the circular screen stored in the memory 1005, and also perform the following operations:
determining that a touch point is the start touch point of a user's finger when it is detected that the user's finger touches the circular screen and it is determined that the touch point is in the edge area corresponding to the circular screen; and
determining that an end point of a sliding track is the end touch point of the user's finger when it is detected that the sliding track of the user's finger starting from the start touch point is in the edge area.

The embodiments of the disclosure provide an embodiment of the touch control method of the circular screen according to the structure of the above terminal device but not limited to the above structure. It should be noted that although the flowchart shows a logic order, under some data, the steps shown or described may be performed by an order different from the order herein.

The execution subject of the method in the embodiment of the disclosure may be a data adjustment device with a circular screen or a terminal device with a circular screen. The embodiment takes the terminal device with the circular screen as the execution subject for example.

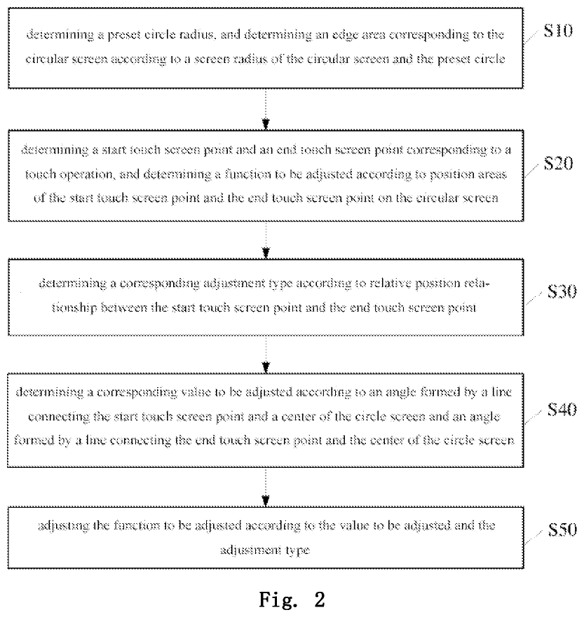

Please refer to FIG. 2, which is a flowchart of a first embodiment of the touch control method for the circular screen of the disclosure. The touch control method for the circular screen is applied to the terminal device with the circular screen, and the touch control method for the circular screen includes:
Step S10, determining a preset circle radius, and determining an edge area corresponding to the circular screen according to a screen radius of the circular screen and the preset circle radius.

It should be noted that the terminal device is used to represents the terminal device with the circular screen in the embodiment, such as a smart watch with the circular screen. The terminal device needs to determine the edge area in the circular screen before the terminal device determines the start touch point and the end touch point corresponding to the touch operation in the circular screen, and the details are as follows: the terminal device determines a screen radius of the circular screen of the terminal device, and determines a preset circle radius of a preset circle in the terminal device, wherein the preset circle radius is set by those skilled in the art according to the size of the terminal device, which is not limited in the embodiment. Then, the terminal device determines a circle area of the circular screen according to the screen radius and the preset circle radius, and determines the circle area as the edge area of the circular screen.

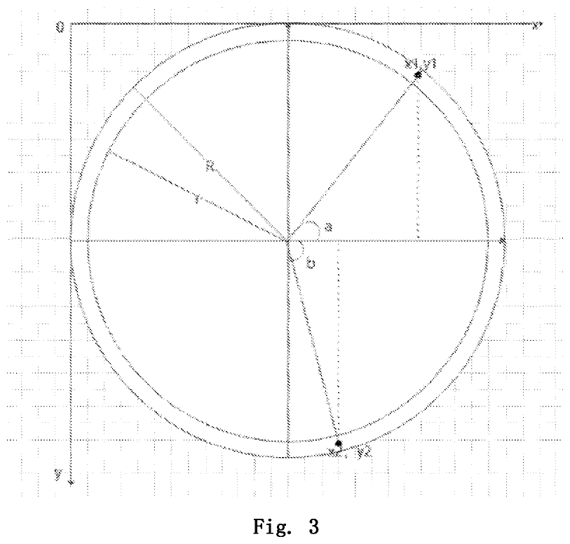

As shown in FIG. 3, FIG. 3 is one application scene graph of the embodiment. The coordinate system as shown in FIG. 3 is built by taking an upper left corner of the circular screen as an origin point, the right side of the origin point as a horizontal coordinate, and the lower side of the origin point as a vertical coordinate. The horizontal coordinates and the vertical coordinates are larger than zero. Therefore, the horizontal coordinates and vertical coordinates of all points in the circular screen are larger than zero. It should be noted that the built method of the coordinate system in FIG. 3 is just for better understanding, and it does not mean that this method is the only one method. Other methods for building the coordinate system may also be a coordinate system built by taking the upper right corner of the circular screen as the origin point, the left side of the origin point as the horizontal coordinate, and the lower side of the origin point as the vertical coordinate, the horizontal coordinates and vertical coordinates are larger than zero. It may also be a coordinate system built by taking the lower left corner of the circular screen as the origin point, the right side of the origin point as the horizontal coordinate, and the upper side of the origin point as the vertical coordinate, the horizontal coordinates and vertical coordinates are larger than zero. It may also be a coordinate system built by taking the top right corner of the circular screen as the origin point, the left side of the origin point as the horizontal coordinate, and the upper side of the origin point as the vertical coordinate, and the horizontal coordinates and vertical coordinates are larger than zero. Similarly, in the coordinate systems built above, the horizontal coordinates and vertical coordinates of all points in the circular screen are larger than zero.

In FIG. 3, the outer circle is the circular screen of the terminal device, R is the screen radius of the circular screen, the inner circle is the preset circle of the terminal device, r is the preset circle radius of the preset circle, and an area between the outer circle and the inner circle is the circle area of the circular screen, that is, the edge area of the circular screen.

Step S20, determining a start touch point and an end touch point corresponding to a touch operation, and determining a function to be adjusted according to position areas of the start touch point and the end touch point on the circular screen.

It should be noted that the touch operation may be a click by a user's finger, or a click by the user with a click pen, which is not limited in the embodiment. For better understanding, the embodiment takes the click by the user's finger as an example.

After the terminal device determines the edge area of the circular screen, when it is detected that the user's finger clicks the circular screen, it is determined that whether the click point of the user's finger is in the edge area. If the click point of the user's finger on the terminal device is in the edge area, the terminal device determines that the click point of the user's finger is the starting touch point. After the terminal device determines the start touch point, the terminal device detects whether there is a sliding track of the user's finger in the edge area. If the terminal device detects that there is the sliding track of the user's finger in the edge area, the terminal device determines that the user's finger triggers an edge area touch event, determines the track end point of the sliding track, and determines the track end point as the end touch point of the user's finger. Then, the terminal device determines the horizontal coordinate corresponding to the start touch point and the horizontal coordinate corresponding to the end touch point, and determines the position areas of the start touch point and the end touch point in the circular screen according to the size relationship between the horizontal coordinate of the start touch point, the horizontal coordinate of the end touch point and the screen radius of the circular screen, and determines the function to be adjusted according to the position areas. Wherein, the function to be adjusted includes adjusting the brightness of the circular screen, adjusting the volume of the terminal device and switching the subject of the circular screen, but is not limited thereto.

It should be noted that only when the start touch point and the end touch point of the user's finger are in the edge area of the circular screen, it can be determined that the edge area touch event is triggered. If the sliding track of the user's finger is not completely in the edge area, the instantaneous track point corresponding to the sliding track breaking away from the edge area is determined as the terminal touch point of the user's finger.

In the embodiment, for example, the function to be adjusted corresponding to the left area of the circular screen is defined as adjusting the brightness of the circular screen, and the function to be adjusted corresponding to the right area of the circular screen is defined as adjusting the volume of the terminal device. In combination with FIG. 3, the coordinate point of the start touch point is (x1, y1), the coordinate point of the end touch point is (x2, y2), the horizontal coordinate of the start touch point x1 is larger than R, and the horizontal coordinate of the end touch point x2 is larger than R, the terminal device determines that the start touch point and the end touch point are in the right area of the circular screen, and the terminal device determines that the function to be adjusted is adjusting the volume of the terminal device.

Further, the step S20 includes:
Step S201, determining that a touch point is the start touch point of a user's finger when it is detected that the user's finger touches the circular screen and it is determined that the touch point is in the edge area corresponding to the circular screen; and
Step S202, determining that an end point of a sliding track is the end touch point of the user's finger when it is detected that the sliding track of the user's finger starting from the start touch point is in the edge area.

Specifically, the terminal device detects that the user's finger clicks the circular screen, and determines that the touch point of the user's finger is in the edge area of the circular screen, thus the terminal device determines that the touch point of the user's finger is the starting touch point. After the terminal device determines the start touch point, if it is detected the sliding track of the user's finger starting from the start touch point and it is determined that the sliding track is in the edge area, the terminal device determines that the user's finger triggers the edge area touch screen event, and determines the end track point of the sliding track as the end touch point of the user's finger.

Wherein, in the embodiment, a Pythagorean theorem calculating method may be used for determining whether the trigger point of the user's finger is in the edge region and whether the sliding track of the user's finger is in the edge region, but it is not only limited to the Pythagorean theorem calculation method. In combination with FIG. 3, the coordinate point of the trigger point of the user's finger is (x1, y1), the coordinate point of the end track point of the sliding track is (x2, y2), R is the screen radius of the circular screen, and r is the preset circle radius of the preset circle, thus it may be understood that the center of a circular screen is (R, R). According to the Pythagorean theorem, if (R−x1)²+(R−y1)²>r², it is determined that the trigger point (x1, y1) is the start touch point. Similarly, if (R−x2)²+(R−y2)²>r², it is determined that the end track point (x2, y2) of the sliding track is the end touch point. The trigger point of (R−x)²+(R−y)²<r² is determined as a non-edge area point, that is, the non-start touch point and the non-end touch point.

Step S30: determining a corresponding adjustment type according to relative position relationship between the start touch point and the end touch point.

After the terminal device determines the function to be adjusted, the vertical coordinate corresponding to the start touch point and the vertical coordinate corresponding to the end touch point are determined, and the terminal device compares the position relationship between the vertical coordinate of the start touch point and the vertical coordinate of the end touch point. If the terminal device determines that the position of the vertical coordinate of the end touch point is below the position of the vertical coordinate of the start touch point, the terminal device determines that the sliding direction of the user's finger is from up to down, that is, the decreasing adjustment type. If the terminal device determines that the position of the vertical coordinate of the end touch point is above the position of the vertical coordinate of the start touch point, the terminal device determines that the sliding direction of the user's finger is from down to up, that is, the increasing adjustment type.

It may be understood that the vertical coordinate of the start touch point is compared with the vertical coordinate of the end touch point, and the adjustment type corresponding to the function to be adjusted is determined according to the comparison result.

Further, if the terminal device determines that the comparison result is the vertical coordinate of the end touch point being larger than the vertical coordinate of the start touch point, that is, if it is determined that the position of the vertical coordinate of the end touch point is below the position of the vertical coordinate of the start touch point, the terminal device determines that the sliding direction of the user's finger is from up to down, that is, the decreasing adjustment type. If the terminal device determines that the comparison result is the vertical coordinate of the end touch point being smaller than the vertical coordinate of the start touch point, that is, if it is determined that the position of the vertical coordinate of the end touch point is above the position of the vertical coordinate of the start touch point, the terminal device determines that the sliding direction of the user's finger is from down to up, that is, the increasing adjustment type.

Further, if the terminal device determines that the comparison result is the vertical coordinate of the end touch point being smaller than the vertical coordinate of the start touch point, that is, if it is determined that the position of the vertical coordinate of the end touch point is below the position of the vertical coordinate of the start touch point, the terminal device determines that the sliding direction of the user's finger is from up to down, that is, the decreasing adjustment type. If the terminal device determines that the comparison result is the vertical coordinate of the end touch point being larger than the vertical coordinate of the start touch point, that is, if it is determined that the position of the vertical coordinate of the end touch point is above the position of the vertical coordinate of the start touch point, the terminal device determines that the sliding direction of the user's finger is from down to up, that is, the increasing adjustment type.

It should be noted that the method used to determine the adjustment type in the embodiment depends on the built method of the coordinate system, which is not limited in the embodiment.

Further, the step S30 includes:
Step S301, determining a first vertical coordinate corresponding to the start touch point, and determining a second vertical coordinate corresponding to the end touch point;
Step S302, determining the relative position relationship between the start touch point and the end touch point according to the relative difference between the first vertical coordinate and the second vertical coordinate; and
Step S303, determining the corresponding adjustment type according to the relative position relationship between the start touch point and the end touch point.

Specifically, in combination with FIG. 3 and the coordinate system in FIG. 3, the terminal device determines the vertical coordinate of the start touch point and the vertical coordinate of the end touch point, and compares the vertical coordinate of the start touch point with the vertical coordinate of the end touch point. If the terminal device determines that the vertical coordinate of the end touch point is larger than the vertical coordinate of the start touch point, that is, if it is determined that the position of the end touch point is located below the position of the start touch point, the terminal device determines that the sliding direction of the user's finger is from up to down, that is, the decreasing adjustment type. If the terminal device determines that the vertical coordinate of the end touch point is smaller than the vertical coordinate of the start touch point, that is, if it is determined that the position of the end touch point is above the position of the start touch point, the terminal device determines that the sliding direction of the user's finger is from down to up, that is, the increasing adjustment type.

In the embodiment, for example, in combination with FIG. 3, the coordinate point of the start touch point is (x1, y1), and the coordinate point of the end touch point is (x2, y2), the function to be adjusted is adjusting the volume of the terminal device. The terminal device determines that y2 is larger than y1, that is, the position of the end touch point is below the position of the start touch point, it is determined that the sliding direction of the user's finger is from up to down, that is, the volume of the terminal device is reduced.

Step S40, determining a corresponding adjustment value according to an angle formed by a line connecting the start touch point and a center of the circle screen and an angle formed by a line connecting the end touch point and the center of the circle screen.

After the terminal device determines the function to be adjusted and the adjustment type corresponding to the function to be adjusted, the angle between the line connecting the start touch point and the center of the circular screen and the line of the diameter perpendicular to the vertical coordinate of the start touch point is determined as the angle of the start touch point, and the angle value of the start touch point is determined according to the vertical coordinate of the start touch point and the screen radius of the circular screen. The angle between the line connecting the end point touch point and the center of the circular screen and line of the diameter perpendicular to the vertical coordinate of the end point touch point is determined as the angle of the end point touch point, and the angle value of the end point touch point is determined according to the vertical coordinate of the end point touch screen and the screen radius of the circular screen. Then, the terminal device determines the angle value need to be adjusted according to the vertical coordinate of the start touch point, the angle of the start touch point, the vertical coordinate of the end touch point and the angle of the end touch point, and the function adjustment value of the function to be adjusted is obtained by calculating according to the angle value need to be adjusted and the current function value of the function to be adjusted.

Step S50, adjusting the function to be adjusted according to the adjustment value and the adjustment type.

After the terminal device determines the function to be adjusted, the adjustment type and the adjustment value, the terminal device determines the current function value of the function to be adjusted, obtains the corresponding target adjustment value by calculating according to the current function value, the adjustment type and the adjustment value, and adjusts the current function value of the function to be adjusted to the target adjustment value.

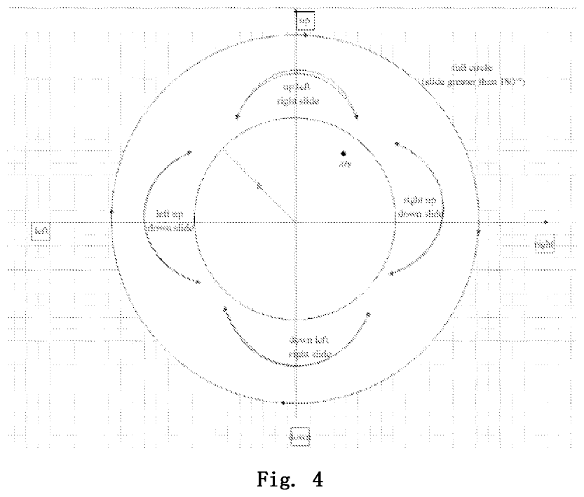

Further, as shown in FIG. 4, FIG. 4 is the types of the edge touch screen events of the embodiment. It should be noted that the built method of the coordinate system in FIG. 4 may refer to the built method of the coordinate system in FIG. 3, that is, taking the upper left corner of the circular screen as the origin point, the right side of the origin point as the horizontal coordinate, and the lower side of the origin point as the vertical coordinate, the horizontal coordinates and vertical coordinates are larger than zero. Therefore, the horizontal coordinates and vertical coordinates of all points in the circular screen are larger than zero. (x, y) in FIG. 4 represents the horizontal coordinate value and vertical coordinate value of the start touch point and the end touch point, and R represents the screen radius of the circular screen. If x of the start touch point and the end touch point <R, the terminal device determines that the type of touch screen event is left up slide or left down slide. If x of the start touch point and the end touch point >R, the terminal device determines that the type of touch screen event is right up slide or right down slide. If y of the start touch point and the end touch point <R, and one x>R and another one x<R, the terminal device determines that the type of touch screen event is up left slide or up right slide. If y of the start touch point and the end touch point >R, and one x>R and another one x<R, the terminal device determines that the type of the touch screen event is left down slip or right down slip. If the sliding area is larger than the whole area, it is considered as a full circle, such as sliding from the top right to the bottom left or the top left.

The embodiment includes: determining a start touch point and an end touch point corresponding to a touch operation, and determining a function to be adjusted according to position areas of the start touch point and the end touch point on the circular screen; determining a corresponding adjustment type according to relative position relationship between the start touch point and the end touch point; determining a corresponding adjustment value according to an angle formed by a line connecting the start touch point and a center of the circle screen and an angle formed by a line connecting the end touch point and the center of the circle screen; and adjusting the function to be adjusted according to the adjustment value and the adjustment type. Thus, it can be known that, in the disclosure, during the process of adjusting the function to be adjusted, the corresponding function to be adjusted, the adjustment type and the adjustment value are determined by the start touch point and the end touch point, and the function to be adjusted is determined by the adjustment value and the adjustment type, so as to realize the shortcut operation of the function to be adjusted in the terminal device with the circular screen.

Please refer to FIG. 5, FIG. 5 is a detailed flowchart of the step S20 in the first embodiment of the touch control method for the circular screen of the disclosure. The step S20 also includes:
Step S203, determining a first horizontal coordinate corresponding to the start touch point, and determining a second horizontal coordinate corresponding to the end touch point;
Step S204, determining a first position area of the start touch point on the circular screen according to the ratio of the first horizontal coordinate to a screen radius of the circular screen;
Step S205, determining a second position area of the end touch point on the circular screen according to the ratio of the second horizontal coordinate to the screen radius of the circular screen; and
Step S206, determining a corresponding function to be adjusted according to the first position area and the second position area.

Specifically, the terminal device determines the horizontal coordinate corresponding to the start touch point and the horizontal coordinate corresponding to the end touch point, determines the position areas of the start touch point and the end touch point in the circular screen respectively according to the size relationship between the horizontal coordinate of the start touch point, the horizontal coordinate of the end touch point and the screen radius of the circular screen, and determines the function to be adjusted according to the position areas of the start touch point and the end touch point. In combination with FIG. 3, the function to be adjusted corresponding to the left area in the circular screen is defined as adjusting the brightness of the circular screen, the function to be adjusted corresponding to the right area in the circular screen is defined as adjusting the volume of the terminal device, and the function to be adjusted corresponding to the circular screen from left to right or from right to left is defined as switching the subject of the circular screen. The coordinate point of the start touch point is (x1, y1), and the coordinate point of the end touch point is (x2, y2). If the horizontal coordinate x1 of the start touch point is less than R, the terminal device determines that the start touch point is in the left area of the circular screen, and if the horizontal coordinate x2 of the end touch point is less than R, the terminal device determines that the end touch point is in the left area of the circular screen. If the start touch point and the end touch point are in the left area of the circular screen, the terminal device determines that the function to be adjusted is to adjust the brightness of the terminal device.

If the horizontal coordinate x1 of the start touch point is larger than R, the terminal device determines that the start touch point is located in the right area of the circular screen, and if the horizontal coordinate x2 of the end touch point is larger than R, the terminal device determines that the end touch point is located in the right area of the circular screen. If the start touch point and the end touch point are located in the right area of the circular screen, the terminal device determines that the function to be adjusted is to adjust the volume of the terminal device.

If the horizontal coordinate x1 of the start touch point is larger than R, the terminal device determines that the start touch point is located in the right area of the circular screen, and if the horizontal coordinate x2 of the end touch point is less than R, the terminal device determines that the end touch point is located in the left area of the circular screen. If the start touch point is located in the right area of the circular screen, and the end touch point is located in the left area of the circular screen, the terminal device determines that the function to be adjusted is to switch the subject of the circular screen.

If the horizontal coordinate x1 of the start touch point is less than R, the terminal device determines that the start touch point is located in the left area of the circular screen, and if the horizontal coordinate x2 of the end touch point is larger than R, the terminal device determines that the end touch point is located in the right area of the circular screen. If the start touch point is located in the left area of the circular screen, and the end touch point is located in the right area of the circular screen, the terminal device determines that the function to be adjusted is to switch the subject of the circular screen.

The embodiment including: determining a first horizontal coordinate corresponding to the start touch point, and determining a second horizontal coordinate corresponding to the end touch point; determining a first position area of the start touch point on the circular screen according to the ratio of the first horizontal coordinate to a screen radius of the circular screen; determining a second position area of the end touch point on the circular screen according to the ratio of the second horizontal coordinate to the screen radius of the circular screen; and determining a corresponding function to be adjusted according to the first position area and the second position area. Thus, in the embodiment, the function to be adjusted corresponding to the trigger event may be determined according to the first horizontal coordinate of the start touch point, the second horizontal coordinate of the end touch point and the screen radius, thus improving the intelligence of the function to be adjusted in the terminal device with a circular screen.

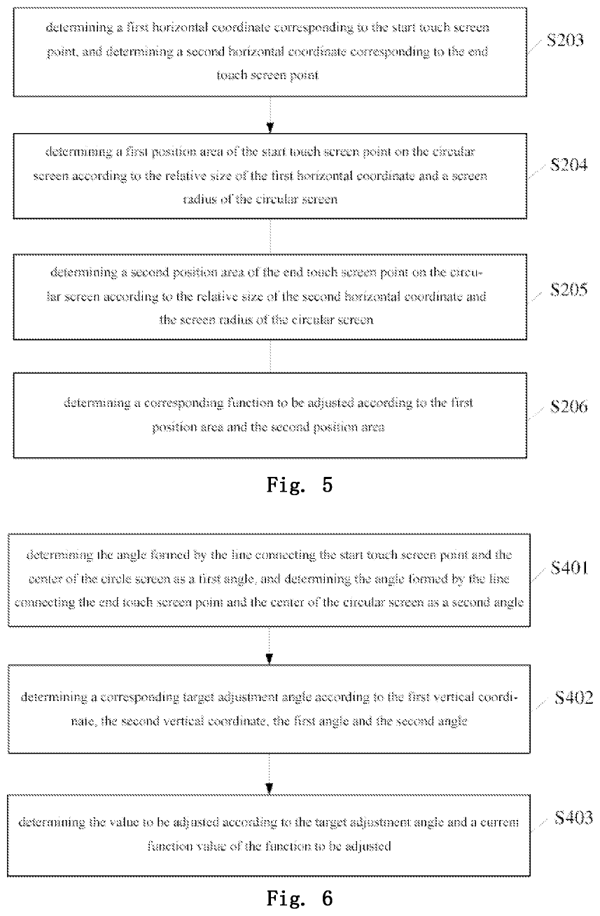

Please refer to FIG. 6, FIG. 6 is a detailed flowchart of a step S40 in the first embodiment of the touch control method for the circular screen of the disclosure. The step S40 includes:
Step S401, determining the angle formed by the line connecting the start touch point and the center of the circle screen as a first angle, and determining the angle formed by the line connecting the end touch point and the center of the circular screen as a second angle;
Step S402, determining a corresponding target adjustment angle according to the first vertical coordinate, the second vertical coordinate, the first angle and the second angle; and
Step S403, determining the adjustment value according to the target adjustment angle and a current function value of the function to be adjusted.

Specifically, the terminal device determines the angle formed by the line connecting the start touch point and the center of the circle screen as an angle of the start touch point, and determines the angle formed by the line connecting the end touch point and the center of the circular screen as an angle of the end touch point. The terminal device calculates the vertical coordinate of the start touch point and screen radius by the trigonometric function to obtain the angle value of the start touch point, and calculates the vertical coordinate of the end touch point and screen radius by the trigonometric function to obtain the angle value of the end touch point. Then, the terminal device compares the vertical coordinate of the start touch point and screen radius, and compares the vertical coordinate of the end touch point and the screen radius, to obtain the corresponding comparison results, and determines the corresponding target adjustment angle according to the comparison results, the angle of the start touch point and the angle of the end touch point. In combination with FIG. 3, if the terminal device determines that the comparison results are the vertical coordinate of the end touch point being larger than the screen radius and the vertical coordinate of the start touch point being smaller than the screen radius, the terminal device will sum the angle of the start touch point and the angle of the end touch point, and the obtained sum value is the target adjustment angle. If the terminal device determines that the comparison results are the vertical coordinate of the end touch point being smaller than the screen radius and the vertical coordinate of the start touch point being smaller than the screen radius, the terminal device will calculate the difference between the angle of the start touch point and the angle of the end touch point, and the obtained difference value is the target adjustment angle. After the terminal device obtains the target adjustment angle, it determines the corresponding adjustment proportion according to the target adjustment angle and the preset angle, and then multiplies the adjustment proportion and the current function value of the function to be adjusted, the obtained product is the adjustment value. Wherein, the preset angle is set by those skilled in the art, which is not limited in the embodiment.

Further, it may be understood that, if the terminal device determines that the comparison results are the vertical coordinate of the end touch point being smaller than the screen radius and the vertical coordinate of the start touch point being larger than the screen radius, the terminal device will sum the angle of the start touch point and the angle of the end touch point, and the obtained sum value is the target adjustment angle. If the terminal device determines that the comparison results are the vertical coordinate of the terminal touch point being larger than the screen radius and the vertical coordinate of the start touch point being smaller than the screen radius, the terminal device will calculate the difference between the angle of the start touch point and the angle of the terminal touch point, and the obtained difference value is the target adjustment angle. The method of calculating the target adjustment angle is determined by the coordinate system.

In the embodiment, for example, in combination with FIG. 3, the coordinate point of the start touch point is (x1, y1), the coordinate point of the end touch point is (x2, y2), the current brightness value is C, the preset angle is 180 degrees, the angle of the start touch point is a, and the angle of the end touch point is b. It should be noted that the trigonometric function formula for calculating the angle a of the start touch point is sin a=1 R−y1 |/R, and the trigonometric function formula for calculating the angle b of the end touch point is sin b=1 R−y2 |/R. Since |R−y1| and |R−y2| are both larger than zero, according to the nature of the trigonometric function, it is determined that the angle a and the angle b are both positive values. If the vertical coordinate y2 of the end touch point is larger than the screen radius R, and the vertical coordinate y1 of the start touch point is smaller than the screen radius R, the terminal device determines that the target adjustment angle is (a+b), and the target adjustment value is D=C*(a+b)/180.

The embodiment including: determining the angle formed by the line connecting the start touch point and the center of the circle screen as a first angle, and determining the angle formed by the line connecting the end touch point and the center of the circular screen as a second angle; determining a corresponding target adjustment angle according to the first vertical coordinate, the second vertical coordinate, the first angle and the second angle; and determining the adjustment value according to the target adjustment angle and a current function value of the function to be adjusted. It can be known that, in the embodiment, the target adjustment angle is determined by the first vertical coordinate, the second vertical coordinate, the screen radius, the first angle and the second angle, and the adjustment value is determined automatically according to the target adjustment angle and the current function value, thus improving the intelligence of determining the adjustment value in the terminal device with the circular screen.

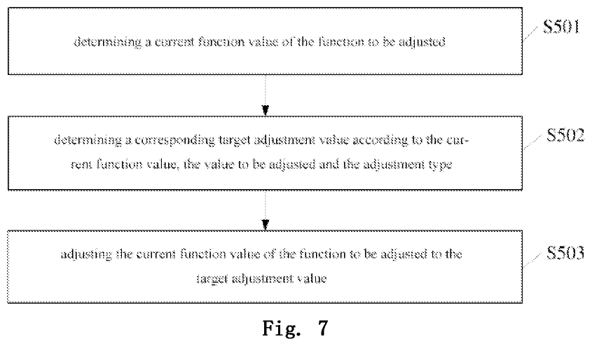

Please refer to FIG. 7, FIG. 7 is a detailed flowchart of a step S50 in the first embodiment of the touch control method for the circular screen of the disclosure. The step S50 includes:
Step S501, determining a current function value of the function to be adjusted;
Step S502, determining a corresponding target adjustment value according to the current function value, the adjustment value and the adjustment type; and
Step S506, adjusting the current function value of the function to be adjusted to the target adjustment value.

After the terminal device determines the function to be adjusted, the adjustment type and the adjustment value, the terminal device determines the current function value of the function to be adjusted. Then, the terminal device determines that the adjustment type corresponding to the function to be adjusted is the increasing adjustment type or the decreasing adjustment type, determines the target adjustment value according to the adjustment value, the adjustment type and the current function value, and adjusts the current function value of the function to be adjusted to the target adjustment value.

Further, in step S502, determining the corresponding target adjustment value according to the current function value, the adjustment value and the adjustment type includes:
Step S5021, determining a sum of the current function value and the adjustment value as the target adjustment value if the adjustment type is the increasing adjustment type; or
Step S5022, determining a difference between the current function value and the adjustment value as the target adjustment value if the adjustment type is the decreasing adjustment type.

Specifically, if the terminal device determines that the adjustment type is the increasing adjustment type, the terminal device will sum the current function value of the function to be adjusted with the adjustment value, and the obtained sum value is the target adjustment value. If the terminal device determines that the adjustment type is the decreasing adjustment type, the terminal device will calculate the difference between the current function value of the function to be adjusted, and the obtained difference value is the target adjustment value.

In the embodiment, for example, in combination with FIG. 3, the coordinate point of the start touch point is (x1, y1), the coordinate point of the end touch point is (x2, y2), the function to be adjusted is to adjust the volume of the terminal device, the current brightness value is C, the preset angle is 180 degrees, the angle of the start touch point is a, and the angle of the end touch point is b. The trigonometric function formula for calculating the angle a of the start touch point is sin a=|R−y1 |/R, and the trigonometric function formula for calculating the angle b of the end touch point is sin b=|R−y2 |/R. Since |R−y1 | and |R−y2 | are both larger than zero, according to the nature of the trigonometric function, it is determined that the angle a and the angle b are both positive values. If the vertical coordinate y2 of the end touch point is larger than the screen radius R, and the vertical coordinate y1 of the start touch point is smaller than the screen radius R, the terminal device determines that the adjustment type is the decreasing adjustment type, the target adjustment angle is (a+b), and the target adjustment value is D=C−C*(a+b)/180.

Further, after step S502, the method further including:
Step S503, detecting whether the target adjustment value is larger than or equal to the maximum function value of the function to be adjusted;
Step S504, if it is detected that the target adjustment value is less than the maximum function value, performing step S506; and
Step S505, if it is detected that the target adjustment value is larger than or equal to the maximum function value, determining that the maximum function value is the target adjustment value, and performing step S506.

Specifically, after the terminal device determines the target adjustment value corresponding to the function to be adjusted, the terminal device detects whether the target adjustment value is larger than or equal to the maximum function value of the function to be adjusted. If the terminal device detects that the target adjustment value is less than the maximum function value of the function to be adjusted, the terminal device will adjust the current function value of the function to be adjusted to the target adjustment value. If the terminal device detects that the target adjustment value is larger than or equal to the maximum function value of the function to be adjusted, the terminal device will determine the maximum function value as the target adjustment value and adjust the current function value of the function to be adjusted to the maximum function value.

The embodiment includes: determining a current function value of the function to be adjusted; determining a corresponding target adjustment value according to the current function value, the adjustment value and the adjustment type; and adjusting the current function value of the function to be adjusted to the target adjustment value. It may be known that the embodiment determines the corresponding target adjustment value automatically according to the current function value, the adjustment value and the adjustment type, and adjusts the current function value of the function to be adjusted to the target adjustment value automatically, thus improving the intelligence of the adjustment of the function value in the terminal device with the circular screen.

The disclosure also provides a touch control device for the circular screen. The touch control device for the circular screen is applied to the terminal device with the circular screen, and the touch control device of the circular screen includes:
a determination module for determining the start touch point and the end touch point corresponding to the touch operation, and determining the function to be adjusted according to position areas of the start touch point and the end touch point on the circular screen;
The determination module also for determining the corresponding adjustment type according to the relative position relationship between the start touch point and the end touch point;
The determination module also for determining the corresponding adjustment value according to an angle formed by a line connecting the start touch point and a center of the circle screen and an angle formed by a line connecting the end touch point and the center of the circle screen; and
An adjustment module for adjusting the function to be adjusted according to the adjustment value and the adjustment type.

Wherein, the realization of the function of each module in the touch control device for the above circular screen corresponds to each step of the above touch control method of the circular screen of the embodiment, and the function and the implementation process thereof will not be described herein.

The disclosure also provides a terminal device including a memory, a processor and a touch control program for a circular screen stored in the memory and running on the processor, wherein when the touch control program for the circular screen is executed by the processor, the steps of the touch control method for the circular screen as described in any of the above embodiments are performed.

The specific embodiments of the terminal device in the disclosure is basically the same as the above embodiments of the touch control method for the circular screen, and will not be described herein.

The disclosure also provides a storage medium on which a touch control program for a circular screen is stored, wherein when the touch control program for the circular screen is executed by the processor, steps of the touch control method for the circular screen as described in any of the above embodiments are performed.

The specific embodiments of the storage medium in the disclosure is basically the same as the above embodiments of the touch control method for the circular screen, and will not be described herein.

It should be noted that the terms “including”, “including” or any other variation thereof herein are intended to cover non-exclusive inclusion, so that a process, a method, an article or a device including a series of elements includes not only those elements, but also includes other elements not explicitly listed, or the elements inherent in such process, method, article or device. In the absence of more restrictive data, the element defined by the statement “including a . . . ” does not exclude the existence of other identical elements in the process, method, article or device including the element.

The above serial number of the embodiments of the disclosure is only for description and does not represent the advantages and disadvantages of the embodiments.

By the description of the above embodiments, it is clearly understood by those skilled in the art that the above embodiments can be achieved by software and necessary general hardware platform, and of course, can also be achieved by hardware, but the former is a better implementation under many data. According to this understanding, the technical solution of the disclosure or the part that contributes to the prior art may be embodied in the form of software goods, which are stored in a storage medium (such as ROM/RAM, a magnetic disk, an optical disk), including several instructions to enable a terminal device to achieve the methods described in various embodiments of the disclosure.

1. A touch control method for a circular screen, wherein the touch control method for the circular screen is applied to a terminal device with the circular screen, and wherein the touch control method for the circular screen comprises:
determining a start touch point and an end touch point corresponding to a touch operation, and determining a function to be adjusted according to position areas of the start touch point and the end touch point on the circular screen;
determining a corresponding adjustment type according to relative position relationship between the start touch point and the end touch point;
determining a corresponding adjustment value according to an angle formed by a line connecting the start touch point and a center of the circle screen and an angle formed by a line connecting the end touch point and the center of the circle screen; and
adjusting the function to be adjusted according to the adjustment value and the adjustment type.

2. The touch control method for the circular screen according to claim 1, wherein adjusting the function to be adjusted according to the adjustment value and the adjustment type comprises:
determining a current function value of the function to be adjusted;
determining a corresponding target adjustment value according to the current function value, the adjustment value and the adjustment type; and
adjusting the current function value of the function to be adjusted to the target adjustment value.

3. The touch control method for the circular screen according to claim 2, wherein the adjustment type comprises an increasing adjustment type and a decreasing adjustment type, and wherein determining the corresponding target adjustment value according to the current function value, the adjustment value and the adjustment type comprises:
determining a sum of the current function value and the adjustment value as the target adjustment value if the adjustment type is the increasing adjustment type; and
determining a difference between the current function value and the adjustment value as the target adjustment value if the adjustment type is the decreasing adjustment type.

4. The touch control method for the circular screen according to claim 1, wherein determining the corresponding adjustment type according to the relative position relationship between the start touch point and the end touch point comprises:
determining a first vertical coordinate corresponding to the start touch point, and determining a second vertical coordinate corresponding to the end touch point;
determining the relative position relationship between the start touch point and the end touch point according to a relative difference between the first vertical coordinate and the second vertical coordinate; and
determining the corresponding adjustment type according to the relative position relationship between the start touch point and the end touch point.

5. The touch control method for the circular screen according to claim 4, wherein determining the corresponding adjustment value according to the angle formed by the line connecting the start touch point and the center of the circle screen and the angle formed by the line connecting the end touch point and the center of the circular screen comprises:
determining the angle formed by the line connecting the start touch point and the center of the circle screen as a first angle, and determining the angle formed by the line connecting the end touch point and the center of the circular screen as a second angle;
determining a corresponding target adjustment angle according to the first vertical coordinate, the second vertical coordinate, the first angle and the second angle; and
determining the adjustment value according to the target adjustment angle and a current function value of the function to be adjusted.

6. The touch control method for the circular screen according to claim 1, wherein determining the function to be adjusted according to the position areas of the start touch point and the end touch point on the circular screen comprises:
determining a first horizontal coordinate corresponding to the start touch point, and determining a second horizontal coordinate corresponding to the end touch point;
determining a first position area of the start touch point on the circular screen according to a ratio of the first horizontal coordinate to a screen radius of the circular screen;
determining a second position area of the end touch point on the circular screen according to the ratio of the second horizontal coordinate to the screen radius of the circular screen; and
determining a corresponding function to be adjusted according to the first position area and the second position area.

7. The touch control method for the circular screen according to claim 1, wherein before determining the start touch point and the end touch point corresponding to the touch operation, the method further comprises:
determining a preset circle radius, and determining an edge area corresponding to the circular screen according to a screen radius of the circular screen and the preset circle radius.

8. The touch control method for the circular screen according to claim 7, wherein determining the start touch point and the end touch point corresponding to the touch operation comprises:
determining that a touch point is the start touch point of a user's finger when it is detected that the user's finger touches the circular screen and it is determined that the touch point is in the edge area corresponding to the circular screen; and
determining that an end point of a sliding track is the end touch point of the user's finger when it is detected that the sliding track of the user's finger starting from the start touch point is in the edge area.

9. A terminal device comprising a memory, a processor and a touch control program for a circular screen stored in the memory and running on the processor, wherein when the touch control program for the circular screen is executed by the processor, steps of the touch control method for the circular screen of claim 1 are performed.

10. A storage medium on which a touch control program for a circular screen is stored, wherein when the touch control program for the circular screen is executed by the processor, steps of the touch control method for the circular screen of claim 1 are performed.
